(19) United States
(12) Patent Application Publication
(10) Pub. No.: US 2015/0020092 A1
(43) Pub. Date: Jan. 15, 2015

(54) METHODS FOR CREATING USER BASED TV PROFILES AND DEVICES THEREOF

(71) Applicant: Infosys Limited, Bangalore (IN)

(72) Inventors: Manav Singal, Panchkula (IN); Inderjeet Singh, Mohali (IN)

(21) Appl. No.: 13/940,458

(22) Filed: Jul. 12, 2013

(51) Int. Cl. H04N 21/4627; H04N 21/45

(52) U.S. Cl. CPC H04N 21/4627; H04N 21/4532
USPC 725/30

(57) ABSTRACT

A computer implemented method executed by one or more computing devices for creating a plurality of access controlled user profile on a first Set Top Box (STB), the method comprises: creating user profile by a first user for the first user and at least a second user, wherein a set of television programs for each of plurality of the users profile is selected and provided to communication service provider; storing each of the plurality of the created users profile on at least a server; associating each of the plurality of the created users profile to the first STB; providing a PIN for each of the plurality of the user profile; and presenting the selected television programs to the user on accessing the user's profiles through the first STB. The method further comprises associating the plurality of the users profile to at least a second STB.

This application claims the benefit of Indian Patent Application Filing No. 2861/CHE/2012, filed Jul. 13, 2012, which is hereby incorporated by reference in its entirety.

### FIELD OF THE INVETION

The present invention relates generally to creating user based profile for viewing TV, and particularly to a system and method for creating plurality of user based TV profile on a single Set Top Box.

### BACKGROUND

Existing TV technology is mostly broadcast or multicast oriented with more unidirectional flow of content. Although the interactivity is being provided through Set Top Box (STB), but personalization and profiling is done at STB level. Profiling is not done at the user level. User profile and package information is associated with STB and that single profile has to be viewed by multiple users. In a house all family members are associated with same profile. In a typical house hold if there are different members of different age group then STB profile does not yield the proper user preference. As a result the TV programming and promotions are not rightly addressed to right demographics. Content creators and advertisers usually spend a lot of money on buying slots for distribution of content over TV networks and are still not able to find out the exact picture of which section of demographics actually liked or disliked the content. T.R.P. and Nielson rating provides the indirect data through survey and questionaries' but that may be inaccurate. STB profiling is also prevalent but does not give discrete idea for user preferences if multiple users of different age group and sex reside in same household. In existing system communication provider does not have full view of user preferences for TV viewing.

Existing prior art does not suggest or anticipate a process to solve the problems for creating and accessing plurality of access controlled profile for TV viewing through a single STB. There is no system to provide personalization of profile at user level. Therefore in the light of existing problems there is need to provide a method and system for creating plurality of access controlled user profile on a single STB for TV viewing.

### BRIEF DESCRIPTION OF THE DRAWINGS

FIG. 1 shows an exemplary process flow for selecting a package and issuing of Set Top Box (STB) to a user;

FIG. 2 shows an exemplary process flow for creating user profile;

FIG. 3 shows an exemplary architecture for selecting channels by users profile on STB;

FIG. 3A shows an exemplary view of selecting a user's profile from list of the users profile and selecting channels for users profile on a STB through interactive TV;

FIG. 4 shows an exemplary process flow for accessing the user profile; and

FIG. 5 shows an exemplary architecture for viewing profile based channels.

FIG. 6 shows an exemplary computing environment.

While systems and methods are described herein by way of example and embodiments, those skilled in the art recognize that systems and methods for creating plurality of user based TV profile on a single STB is not limited to the embodiments or the diagrams described. It should be understood that drawings and descriptions are not intended to be limiting to the particular form disclosed. As used herein, the word “may” is used in a permissive sense (i.e., meaning having the potential to) rather than the mandatory sense (i.e., meaning must). Similarly, the words “include”, “including”, and “includes” mean including, but not limited to. Similarly for the purpose of description terms ‘customers’ and ‘users’, and ‘channels’ and ‘television programs’ are used interchangeably.

### DETAILED DESCRIPTION

Disclosed embodiments provide computer-implemented method and system for creating plurality of access controlled user profile on a single set top box for viewing the TV program of user's choice.

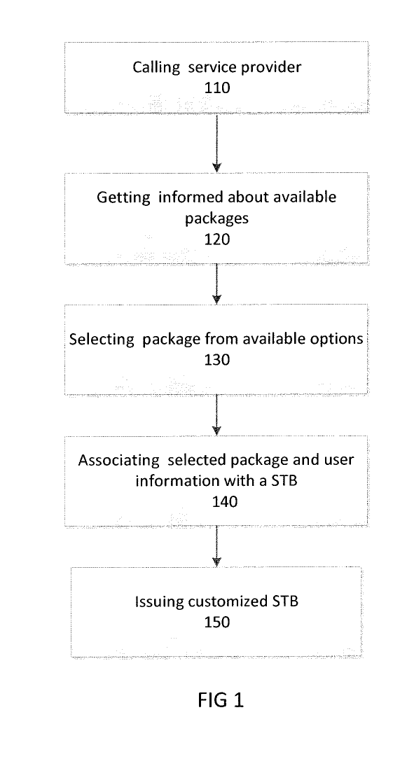

FIG. 1 shows an exemplary process flow for selecting a package and issuing Set Top Box (STB) to a user. The process comprises of customer calling a service provider 110, customer getting informed about available packages 120, customer selecting package from available options 130, service provider associating selected package and user information with STB 140, and service provider issuing customized STB to customer 150. According to an embodiment of the invention the customer or user calls a service provider of TV channels for service related information and subscription of package. The package here includes the set of channels provided by the service provider. Further the customers are informed by the service providers about the available packages. The customers select the desired package from the available options. The service providers associate the selected package and user information with a STB. Then the customized STB with stored selected package and information is issued to the customer. The package includes the list of channels and advertisements targeted for various classes of viewers.

According to an embodiment of the invention same set of users profile can be associated to a plurality of STB thus creating a group of similar STB in a household. The said plurality of STB can be issued to the house hold owner. The plurality said of STB can be kept at different locations in a house and associated users profile can be accessed at any of these locations in the house.

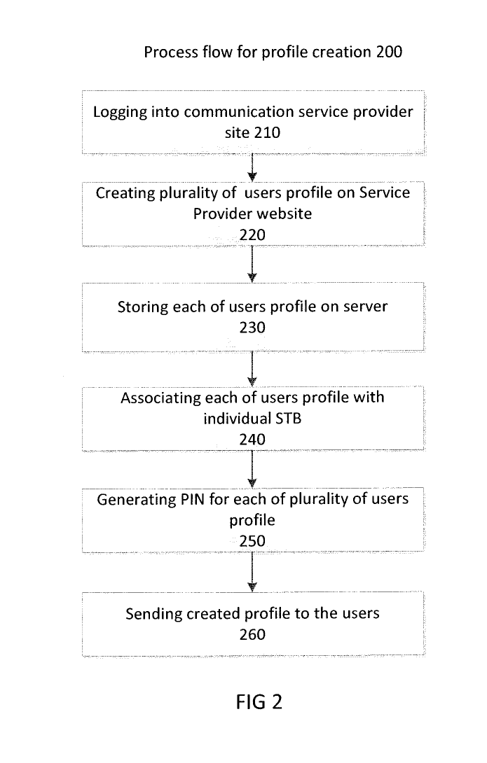

FIG. 2 shows an exemplary process flow for creation of profile. The process comprises of step 210 for logging of household owner into communication service provider site, step 220 for creating a plurality of users profile on service provider site, step 230 for storing each of plurality of the created users profile on server, step 240 for associating each of plurality of users profile to an individual STB, step 250 for generating PIN for each of plurality of users profile, step 250 for sending created profile to the user.

According to an embodiment of the invention the house hold owner logs into the communication service provider's website step 210. After logging in the house hold owner create plurality of individual users profile on service provider website, step 220. Plurality of individual users includes the family members of the family. A plurality of profiles can be created on plurality of demographic details. The plurality of demographic details includes attributes like age, location, gender, location, notification mechanism and identities.

The created plurality of users profile is stored on server, step 230. The created profiles are stored on the server by subscriber management system. Subscriber management system is a combination of machines and human activities and is a part of technical chain that helps organize and operate the business. The plurality of created users profile is associated with an individual STB 370, step 240. Same set of users profile can be associated with a plurality of STB based upon the requirement of the household owner. When STB 370 is powered on it will fetch list of profiles associated with particular customer account. Further an individual PIN is generated for each of the plurality of user's profiles, step 250. The PIN is generated by subscriber management system. Further the created profile is sent to the users through the email or short messages services (SMS) to email id or mobile number respectively registered with the service provider website, step 260. Furthermore the users profile can be sent to household owner as well as individual users based upon the contact details provided.

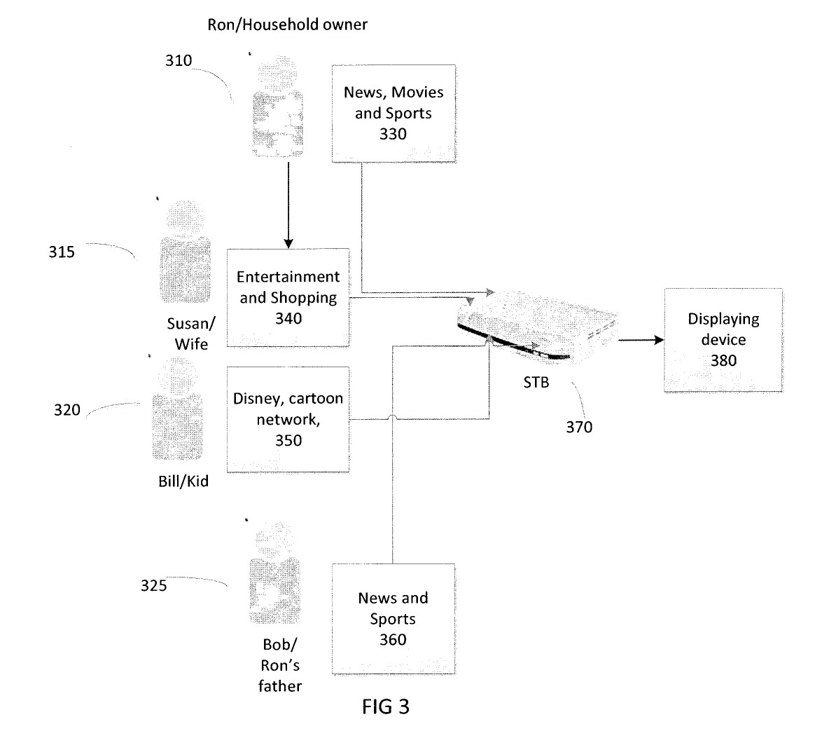

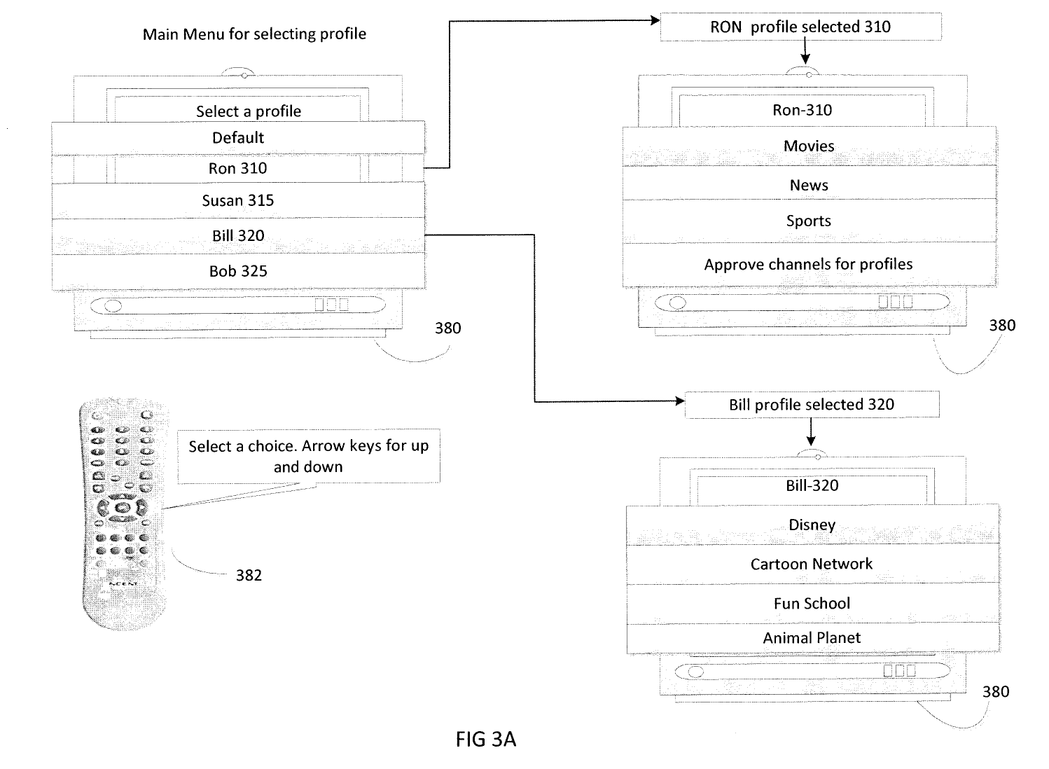

FIG. 3 shows an exemplary architecture for selecting channels by user profile. In an example four members of a family 310, 315, 320 and 325 can make a profile of their choice on single STB 370. According to an embodiment of the invention the channels or programs of the user's choice are displayed on the displaying device 380. The displaying device includes but is not limited to television or home theater. The user 310 can choose a group of channels 330 of their choice, the group can comprise of channels like news, movies and sports, 315 can choose a group of channels of its choice, the group can comprise channels like entertainment and shopping, 320 can choose a group of channels, the group of channels can comprise family channels, 425 can choose a group of channels, the group comprise the channels like news and sports.

FIG. 3A shows an exemplary view of selecting a user's profile from list of the users profile and selecting channels for users profile on a STB through interactive TV. According to an embodiment of the invention after receiving the user profile and associated PIN individual users can log on to their respective profile and select the channels from bouquet of channels subscribed. Further the user may select the basic configuration like sharing presence information, adding contact buddies, notifications to be subscribed, etc. The channels selected by user may be flagged based on age group and may require approval from house hold owner. The household owner gets a request in his or her profile for review and approval of channels selected by the plurality of users. Household owner can mark some of the channels as inappropriate for a particular user. Further household owner can superimpose the users' choice of channels. Furthermore the invention enables house hold owner to authorize and approve the channel preferences for the family members. Further the user gets the list of channels which are chosen by him/her and approved by household owner. Further the users can edit their choice preferences from time to time. Every time a user makes some variations in the choices preferences same is intimated to the household owner. Furthermore the addition or deletion of channels requires the approval from the household owner.

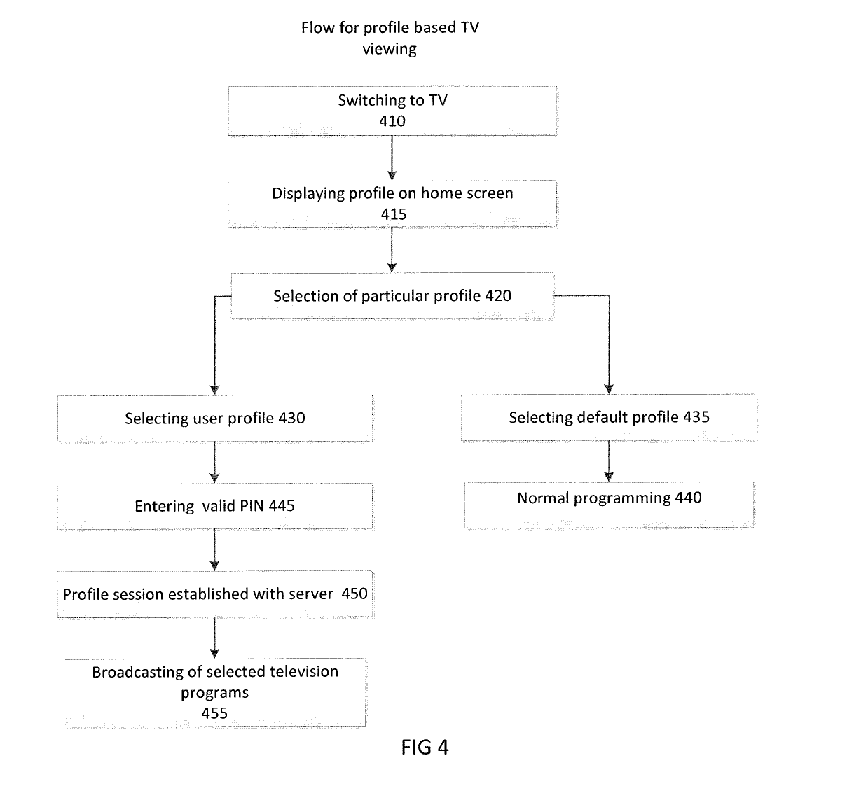

FIG. 4 shows an exemplary process flow for accessing the user profile. It comprises of steps; switching to TV 410, displaying profile on TV screen 420, selection of a particular profile 425, selecting user profile 430, selecting default profile 435, normal programming 440, entering PIN 445, establishment of profile session with server 450, Broadcasting of selected channels 455.

According to an embodiment of the invention the displaying device 380 is connected to a STB 370. In step 410 User switches on TV connected to a STB with full interactive connection with server. Server can detect different set of channels which have been accessed through a given STB. Further the server can detect whether the said STB is provisioned for accessing the given set of channels or not. Once the user switches on the TV the plurality of profiles are displayed on the TV screen. Further the profiles displayed comprise of users profile 430 and default profile 435. Default profile 435 is the profile which consists of set of channels which is customized by the choice of service provider. User profile 430 is the profile created by service provider on request of user wherein user selects a list of favorite content or channels from the list provided by the service provider. A user profile 430 is customized depending upon the choice and preferences of the user. Further each of users' profile 430 can be selected from list of profiles in the menu on a STB 370. Furthermore the default profile 435 can be invoked through a STB 370 incase normal viewing or profile is desired, step 440. Default profile may not require any PIN to be provided for accessing it.

According to an embodiment of the invention a user's profile can be accessed by entering a valid PIN 445. Each user profile is associated with a PIN unique to the user-id or user profile. The PIN is generated once the users profile is created and stored on the server. Further the server is connected to a STB 470 through which users profile can be regulated. Further PIN can be updated or changed depending upon the requirement of the user. Further resetting of PIN can be done by house hold owner or users themselves. The request for resetting and updating the PIN can be entered through STB by using at least an input device. The input devices includes but is not limited to remote, keyboard, touch input device. Step 450 depicts the establishment of profile session with server. Further the server authenticates the establishment of the profile session with server, step 450. Furthermore the STB 470 is authenticated by the server. STB 470 transmits all the details to the server. Details transmitted includes but is not limited to session duration of a profile, the channels watched, interactive response done through STB, notifications received by respective user profiles, pay TV transactions, profile ID and STB ID. Furthermore the interactive response includes but is not limited to voting and polling.

According to an embodiment the invention enables the service provider for normalization of user's profile. Every time a user login and view the program of their choice the preferences are stored on the server. The subscriber management system normalizes the profiles based upon the demographic information and session information without compromising the privacy of individual users. This enables the service provider to detect the viewing preferences of the users based on session which STB creates with server. Further this enables to provide analytics in terms of viewing patterns across user categories. It enables to understand the viewing pattern across different user groups based on gender and ages. It also enables to understand the time preferences across the user groups. It further helps service providers to target advertisement and content which is meaningfully consumed by right user groups. It also enables service provider for buying slots for distribution of content over TV networks. It further helps to broadcast the programs at right time which are meaningfully consumed and enables them to increase their target rating point (TRP).

According to an embodiment the invention facilitates the service provider for easy bill plans. Further billing happens based on the profile which is invoked. The usage is tracked based upon the duration for which the profile was active. This invention enables the service provider to understand the watching pattern of users based upon age, gender and time preferences which may help the service provider to know the minute details to plan the services according to need of users. Further it facilitates the service provider to make a prepaid plan based upon the user preferences. It also facilitates the user to know about the payment of content in advance and choose accordingly. Further it enables service providers to provide for pay per view and pay per hour for the programs thereby increasing the pay plans for users and TRPs for service provider.

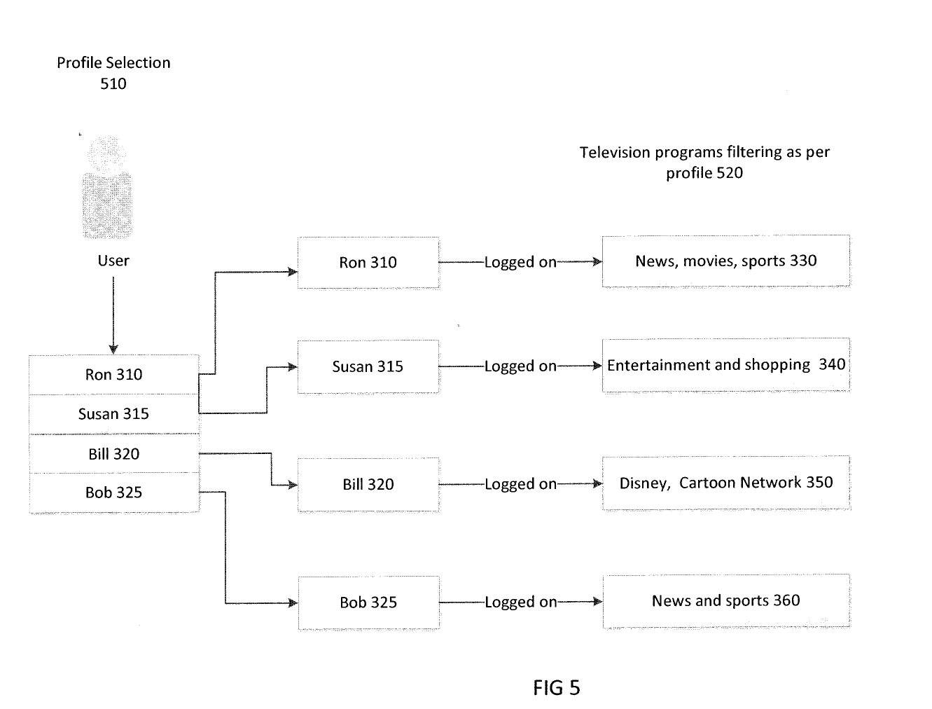

FIG. 5 shows an exemplary architecture for selecting profile of user's choice. According to an embodiment of the invention, once the user switch on the STB 470 and displaying device 480 they are able to see all the profile. The members may select the profile and logon by providing PIN through STB 470 using the input device. In an example, users 410, 415, 420 and 425 from a family logs into their respective profile and access the channels of their own choice. The users select the profile and enter the associated PIN. Entering the associated PIN in a given profile gives an access to the channels of user's choice.

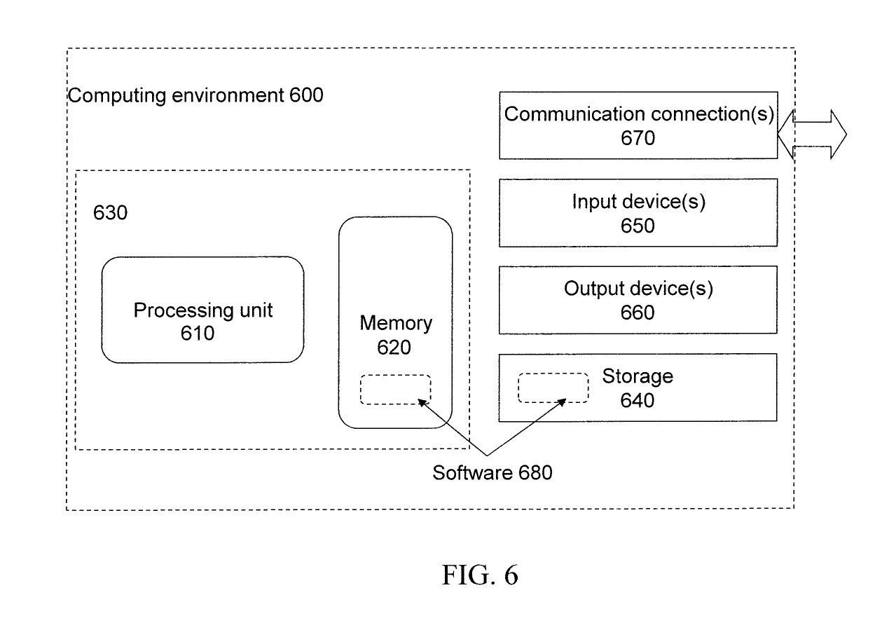

FIG. 6 shows an exemplary computing environment.

One or more of the above-described techniques can be implemented in or involve one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which can be used to store information and which can be accessed within the computing environment 600. In some embodiments, the storage 640 stores instructions for the software 680.

The input device(s) 650 may be a touch input device such as a keyboard, mouse, pen, trackball, touch screen, or game controller, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 600, computer-readable media include memory 620, storage 640, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method for creating a plurality of access controlled profiles on a first Set Top Box (STB), the method comprising:
creating, by a subscriber management computing device, a plurality of user profiles based on information input by a first user for the first user and at least a second user, wherein a set of television programs for each of the plurality of the user profiles is selected and provided to a communication service provider;
storing, by the subscriber management computing device, each of the plurality of the created user profiles on at least a server;
associating, by the subscriber management computing device, each of the plurality of the created user profiles to the first STB;
providing, by the subscriber management computing device, a personal identification number (PIN) for each of the plurality of the user profiles; and
presenting, by the subscriber management computing device, the selected television programs to the user when the user profile is accessed through the first STB.

2. The method of claim 1, further comprising:
associating, by the subscriber management device, the plurality of the user profiles to at least a second STB.

3. The method of claim 1, wherein the first STB is in a full interactive session with server.

4. The method of claim 1, wherein a user profile session is established with the server every time the user profile is accessed.

5. The method of claim 1 wherein each of the plurality of the user profiles comprises a plurality of demographic details, comprising at least one of a user name, an age, a gender, a region or the set of television programs.

6. The method of claim 1, wherein each of the plurality of the users selects the television programs of their choice from a list of television programs provided by the communication service provider.

7. The method of claim 1, wherein the first user receives a notification about the television programs selected by the second user.

8. The method of claim 1, wherein the television programs selected by the second user are approved by the first user.

9. The method of claim 1, wherein each of the plurality of the users has a provision to edit the selected television programs.

10. The method of claim 1, wherein the first user has a provision to edit the selected television programs and the second user does not have the provision to edit the selected television programs.

11. The method of claim 1, wherein each of the plurality of the users accesses their user profile through the first STB by entering the provided PIN.

12. The method of claim 1 wherein the PIN is generated by a module used by the communication service provider.

13. The method of claim 1, wherein the communication service provider captures a users viewing pattern by using a capturing module.

14. The method of claim 1, wherein the communication service provider normalizes the users profile based on a plurality of parameters comprising at least one of an active user profile session, one or more demographic details or one or more user viewing preferences.

15. A subscriber management computing device comprising:
a memory; and
a processor operatively coupled to the memory, the processor configured to perform the steps comprising:
creating a plurality of user profiles based on information input by a first user for the first user and at least a second user, wherein a set of television programs for each of plurality of the users profile is selected and provided to a communication service provider;
storing each of the plurality of the created users profile on at least a server;
associating each of the plurality of the created user profiles to the first STB;
providing a personal identification number (PIN) for each of the plurality of the user profiles; and
presenting the selected television programs to the user when the user profile is accessed through the first STB.

16. The device of claim 15, wherein the processor is further configured to perform the step of:
associating the plurality of the user profiles to at least a second STB.

17. A non-transitory computer readable medium having stored thereon instructions for creating a plurality of access controlled profiles on a first Set Top Box (STB) comprising machine executable code, which when executed by a processor, causes the processor to perform steps comprising:
creating a plurality of user profiles based on information input by a first user for the first user and at least a second user, wherein a set of television programs for each of plurality of the user profiles is selected and provided to a communication service provider;
storing each of the plurality of the created user profiles on at least a server;
associating each of the plurality of the created user profiles to the first STB;
providing a personal identification number (PIN) for each of the plurality of the user profiles; and
presenting the selected television programs to the user when the user profile is accessed through the first STB.

18. The medium of claim 17, further comprising:
associating the plurality of the user profiles to at least a second STB.
